(19) United States
(12) Patent Application Publication
(10) Pub. No.: US 2015/0102611 A1
(43) Pub. Date: Apr. 16, 2015

(54) Bolt with Wave Structure

(71) Applicant: ASSA ABLOY Sicherheitstechnik GmbH, Albstadt (DE)

(72) Inventors: Edwin Bunschoten, Brummen (NL); Erwin Marcel Brouwer, Ugchelen (NL); Marcel Koelman, Nijmegen (NL)

(21) Appl. No.: 14/403,836

(22) PCT Filed: May 29, 2013
(86) PCT No.: PCT/EP2013/061123

§ 371 Date: Nov. 25, 2014

(30) Foreign Application Priority Data
Jun. 1, 2012 (DE) 102012010787.0
Jan. 11, 2013 (DE) 102013000284.2

(51) Int. Cl. E05C 1/08; E05B 15/04; E05B 15/10; E05B 9/02

(52) U.S. Cl. CPC E05C 1/08; E05B 9/02; E05B 15/04; E05B 15/101
USPC 292/164

(57) ABSTRACT

A lock for a door, window or similar is described, with a lock case (1) and a lock mechanism mounted in the lock case (1) with a bolt (3) which is mounted so as to be retractable and throwable and/or a spring-mounted retractable and throwable latchbolt (2). For improved protection against break-ins it is provided that the body of the bolt (3) has at least one external surface which extends along the direction of movement of the retracting and throwing motion and, along this direction of extension, has a constant surface profile which is formed to be uneven in the direction transverse to the direction of movement, with at least one peak and at least one trough. Particularly preferred are embodiments in which all external surfaces which extend in the direction of movement of the retracting and throwing motion have a wave structure.

The invention relates to a lock for a door, window or similar.

The invention starts from a state of the art in which locks with a lock case and a lock mechanism mounted in the lock case are known, the lock mechanism of which can be actuated via a manual and/or motor-driven actuator. The lock mechanism has a retractable and throwable bolt and/or a spring-mounted retractable and throwable latchbolt. As a rule, the bolt is formed as a cuboid body and the latchbolt is formed with a bevelled surface at its free end as a lead-in bevel.

The locks more or less bar break-in attempts. By inserting flat housebreaking tools it is possible, however, to interfere with the lock mechanism in order to manipulate or damage it.

The object of the invention is to develop a lock in such a way that it becomes more secure against break-ins.

The invention achieves the object with the subject-matter of claim 1. This solution according to the invention involves a lock for a door, window or similar. The lock has a lock case and a lock mechanism, mounted in the lock case, which can be actuated via a manual and/or motor-driven actuator. The lock mechanism has a bolt which is mounted so as to be retractable and throwable and/or a spring-mounted retractable and throwable latchbolt. In the forend-side area of the lock case an opening assigned to the bolt or an opening assigned to the latchbolt is provided, through which the bolt or the latchbolt reaches in at least one locking position. The lock case can be closed off on the forend side by a separate plate—a so-called lock plate. The lock plate features the opening assigned to the bolt or the opening assigned to the latchbolt and can form the forend-side wall of the lock case.

To increase the security against break-ins, it is provided that the body of the bolt and/or the body of the latchbolt has at least one external surface which extends along the direction of movement of the retracting and throwing motion and which has a constant surface profile along this direction of extension at least in the locking section. By the term “body” of the bolt or of the latchbolt is meant the main body of the bolt or of the latchbolt which, during the retracting and throwing, passes through the forend-side opening of the lock case and, in the thrown locking position of the bolt or of the latchbolt, interacts with a striking plate assigned to the lock, i.e. engages in it or otherwise interacts with it during locking. The body is coupled to a gear of the lock mechanism at its lock-side end. For this purpose it can have corresponding connecting elements.

The body of the bolt can be formed in one piece or also composed of several pieces. It is important that the surface profile is formed to be uneven in the direction transverse to the direction of movement, with at least one peak and at least one trough. The surface profile can, for example, be formed as a wave structure or have several differently unevenly designed areas formed transverse to the direction of movement, e.g. different curvatures or other convex or concave moldings.

In order particularly effectively to prevent unauthorized interference with the lock mechanism in the lock case, the invention provides for an opening in the forend-side area of the lock case, preferably in the lock plate, to be assigned to the bolt and/or the latchbolt, through which opening the bolt or the latchbolt can be retracted or thrown, wherein the opening has an opening edge which is formed complementary to the contour of the surface profile of the at least one uneven external surface of the body. In order to prevent, in a lasting manner, break-ins with a housebreaking tool, it is provided in this connection that, at least in the thrown locking position of the bolt or of the latchbolt, the contour of the opening edge of the opening is arranged with only a little play to the contour of the surface profile of the assigned uneven external surface. This means that the cross section of the opening of this gap is advantageously formed with only a small constant width. An even, flat housebreaking tool then cannot be inserted easily.

Several locking positions of the bolt can be provided, which differ in that the bolt is thrown by different amounts. In the locking position, for protection against break-ins, it is necessary in each case for the gap to the opening edge of the forend-side opening to be small and for the contour of the opening edge to be correspondingly matched to the uneven surface profile. For this purpose, the external surface of the body of the bolt must be formed with the uneven surface profile at least in the locking section in question, i.e. the section which forms the gap with the opening edge in the locking position. Embodiments of the bolt are possible in which only one locking position is provided and only one section of the bolt body is provided as locking section. Preferred embodiments can be designed in such a way that the entire external surface of the bolt body, which extends along the direction of movement of the retracting and throwing motion, has a constant uneven surface profile along this direction of extension. This also correspondingly applies to the design of the latchbolt and of the assigned forend-side opening. The latchbolt can also have one or more locking positions which differ in that the latchbolt is thrown by different amounts in these positions. In particular in the case of so-called self-locking latchbolts, two thrown positions of the latchbolt are provided.

Embodiments of the bolt and of the latchbolt are therefore provided which have several locking sections along their direction of movement. The number of locking sections corresponds here to the number of locking positions of the bolt and of the latchbolt. Between the locking sections, the bolt or the latchbolt can be formed with another cross section narrowed as required. In preferred embodiments, it is provided that the uneven surface profile of the at least one external surface extends constantly and continuously over the entire extension of the external surface in the direction of movement of the retracting and throwing motion.

In preferred embodiments, the body of the bolt or of the latchbolt is uneven on several of its external surfaces which extend in the direction of movement during throwing and retracting, preferably on all external surfaces which extend in this direction.

The surface profile of the uneven external surface can be formed convex, but also concave, as well as convex in one area and concave in another area. Concave or convex can, in each case, be formed with a curved surface, but also with an angular surface. Embodiment examples are particularly preferred in which the surface profile has a wave structure, wherein the waves extend along the direction of movement of the retracting and throwing motion. Instead of a wave structure with preferably curved surfaces, the surface profile can also have a toothed structure, wherein the teeth extend along the direction of movement of the retracting and throwing motion.

The waves or the teeth can be formed to be different in the structure in question in each case, in particular adjacent waves or adjacent teeth can be formed to be different. However, teeth that are e.g. adjacent in groups can also be formed the same.

In preferred simple embodiments the waves of the wave structure or the teeth of the toothed structure are formed identical in each case. If the waves or the teeth are designed to be different, periodic designs are particularly preferred.

Preferred embodiments provide that the body of the bolt or of the latchbolt is formed substantially as a cuboid which, transverse to the direction of movement of the retracting and throwing motion, has a cross section which is constant over the entire extension of the body in this direction, and that all external surfaces extending in the direction of movement of the retracting and throwing motion are formed with an uneven surface profile. The uneven structure of the surface of the surface structure extending in the throwing and retracting direction can be identical on the different longitudinal external sides of the cuboid or at least on the external surfaces lying opposite each other in pairs.

The preferably spring-supported latchbolt can also be formed with external surfaces with an uneven surface structure, namely at least in the locking sections, the surfaces which extend in the retracting and throwing direction. In addition, the latchbolt preferably has a bevel which is formed as a lead-in bevel. This bevel is preferably designed as an even surface. In preferred embodiments of this type it is provided that the body of the bolt or of the latchbolt is formed substantially as a cuboid with an end section as a prism with a triangular cross section and has at least one external surface which is formed as an even bevelled surface as a lead-in bevel, wherein at least one of the other external surfaces of the body which extend in the direction of movement of the retracting and throwing motion is formed as an external surface with an uneven surface profile. In preferred developments it can be provided that two external surfaces of the body which lie opposite each other and are connected to each other via the bevel are formed as external surfaces with an uneven surface profile.

Embodiments are particularly practicable in which it is provided that the body of the bolt or of the latchbolt has the design of a body which is formed from several elongate rods which are arranged next to each other transverse to their longitudinal extension and are connected to each other in one piece lengthwise adjoining each other in the longitudinal direction. In these embodiments, it can preferably be provided that at least some of the elongate rods are formed to be different in their cross-sectional shape and/or in their cross-sectional size.

Embodiments are advantageous in which the cross-sectional shape of the elongate rods and/or the cross-sectional size of the elongate rods are formed identical. Embodiments in which rods are formed to be different in terms of their cross-sectional shape and/or their cross-sectional size can, however, offer particular advantages in respect of inhibiting break-ins. The bolt and/or the latchbolt can also involve self-locking embodiments, preferably embodiments with an unlocking pin. In preferred embodiments, the unlocking pin runs axially in a central axis of the bolt or of the latchbolt but can also run eccentrically and also externally on the bolt or the latchbolt.

In the following, an embodiment example is described in more detail with reference to a drawing.

There are shown in:

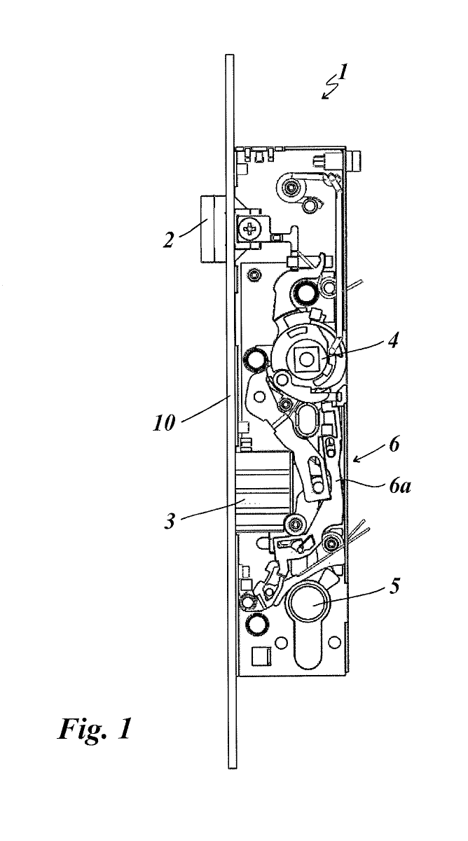

FIG. 1 a side view of a lock with a bolt with a wave-structure external surface, the bolt in the retracted position,

FIG. 1a a side view of a lock with a bolt with a wave-structure external surface, the bolt in the thrown position,

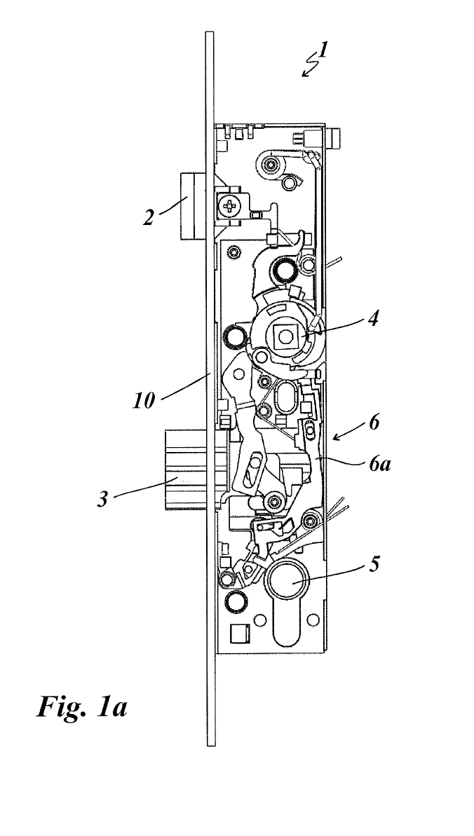

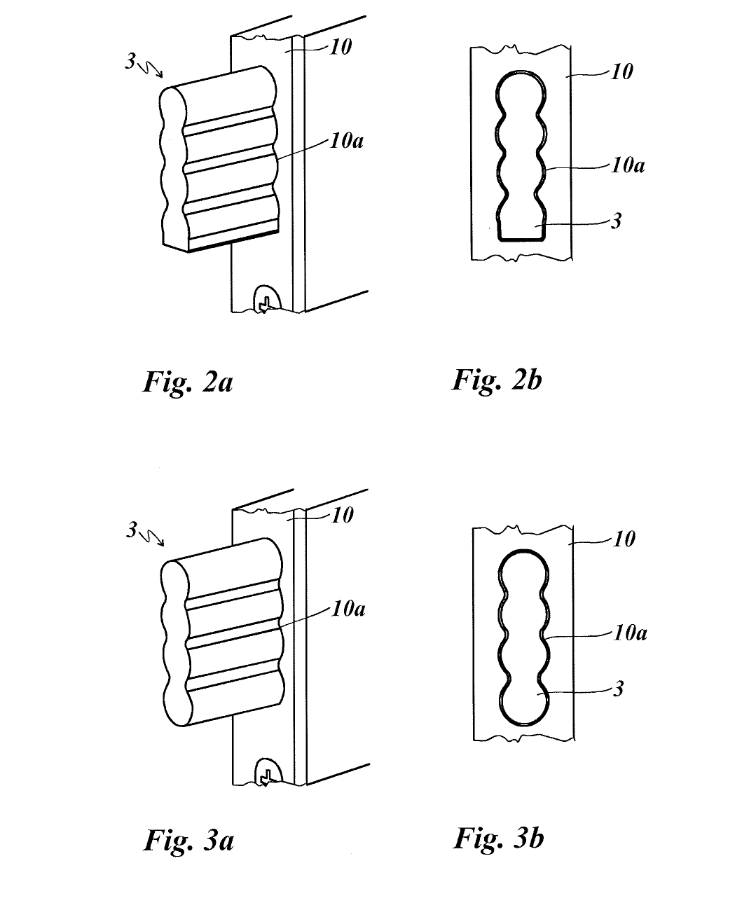

FIG. 2a a perspective oblique view of the forend-side area of the lock case with the bolt according to a first embodiment in the thrown position,

FIG. 2b a front view in FIG. 2a,

FIG. 3a a perspective oblique view of the forend-side area of the lock case with a bolt according to a further embodiment in the thrown position,

FIG. 3b a front view in FIG. 3a,

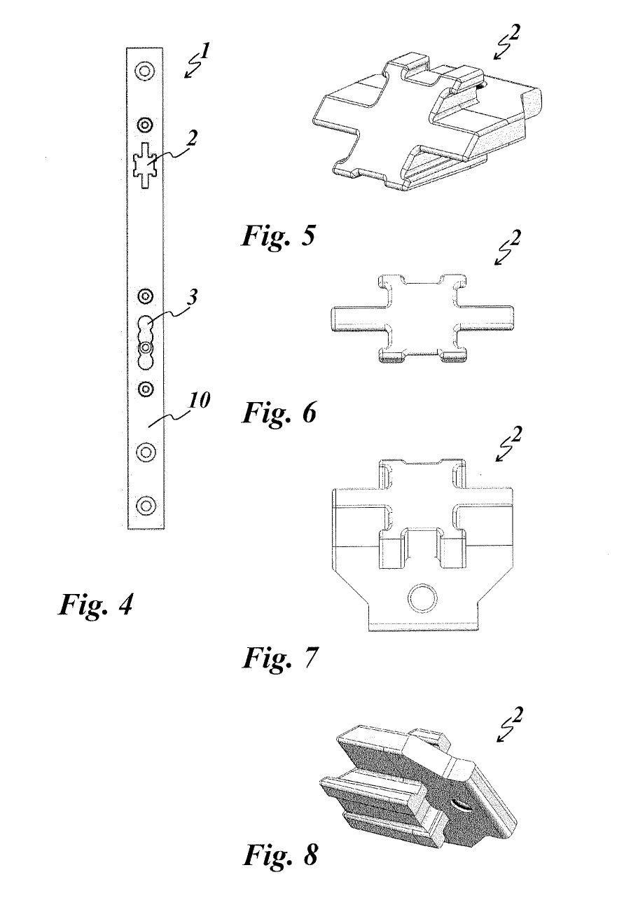

FIG. 4 an end-side front view of the forend-side area of the lock case with a latchbolt with a substantially cross-shaped striking bevelled surface,

FIG. 5 the latchbolt with the substantially cross-shaped striking bevelled surface in a perspective oblique view,

FIG. 6 the latchbolt with the substantially cross-shaped bevelled surface in a top view of the striking bevelled surface,

FIG. 7 the latchbolt with the substantially cross-shaped bevelled surface in a top view,

FIG. 8 the latchbolt with the substantially cross-shaped bevelled surface in a perspective oblique view.

The embodiment example shown in the figures is, in each case, a lock. As FIGS. 1 and 1a show, the lock has a lock case 1. A lock mechanism is mounted in the lock case 1. The lock mechanism comprises a spring-mounted latchbolt 2 and a bolt 3 as well as a nut 4 for attaching an actuator which is not shown. The actuator can be formed as a manual handle, e.g. as a door handle; but it can also be formed as a motor-driven actuator.

The lock further has, in the lock case 1, a lock cylinder 5 and a triggering mechanism 6. The lock cylinder 5 can be actuated by a key and in the process controls the triggering mechanism 6. The triggering mechanism 6 has an actuating arm 6a which interacts, with one of its ends, with the lock cylinder 5 and, with its other end, with the bolt 3. By actuating the lock cylinder 5 using the key, the actuating arm 6a of the triggering mechanism 6 is displaced and the bolt 3 is thereby controlled.

In the embodiment example shown, the bolt 3 is formed as a substantially cuboid body. It is mounted in the lock housing 1 so as to be displaceable linearly, namely along its longitudinal extension. During the pushing movement, the bolt 3 reaches, with the free end of its body, through an opening 10a in the forend-side housing wall of the lock case 1. In the case shown, the forend-side housing wall is formed by a lock plate 10. The opening 10a in the lock plate 10 has an opening cross section which is complementary to the cross section of the bolt 3, namely in such a way that the bolt 3 is guided into the edge of the opening 10a with only a little play. It is important that the body of the bolt 3 has uneven profiled surfaces on its external surfaces extending in the longitudinal direction. The two large longitudinal side surfaces of the body which lie opposite each other have a wave structure. The two end-side longitudinal surfaces which lie opposite each other are convexly curved, namely, in the case shown, forming a single wave crest. The body therefore has, transverse to its longitudinal extension, a cross section which consists of five substantially circular sections which are arranged next to each other in a row, wherein in each case adjacent circular sections border each other in the row and are connected merging into each other. The body therefore has the design of a body which is formed from several rods with a circular cross section, wherein the rods lie next to each other in a row and the, in each case adjacent, rods border each other on their longitudinal side and merge into each other connected in one piece in this area.

The external surfaces extending in the longitudinal direction of the body therefore have an uneven surface profile. The gap to the complementary opening edge of the throwing opening in the lock case 1 and forend 10 thus obtains a gap cross section which corresponds to the contour of the surface profile. Protection against break-ins is thereby obtained. The insertion of a housebreaking tool is substantially hindered as a flat tool cannot be inserted into the gap.

In FIGS. 2a, 2b and 3a, 3b in each case two different embodiments of a bolt are shown. FIGS. 2a and 2b show, for the first embodiment, the forend-side area of the lock case 1 with the bolt 3 according to a first embodiment. Here, the bolt 3 is represented in its thrown position, i.e. the locking position. The body of the bolt 3 is formed substantially as a cuboid, wherein three of the external surfaces have an uneven surface profile. In this embodiment, only the external surface of the bolt 3 which faces downwards in the figures has an even surface profile. It can be seen that the opening edge of the opening 10a in the forend-side housing wall is formed complementary to the surface profile of the bolt 3.

In FIGS. 3a and 3b, the further embodiment of the bolt 3 is shown. In this embodiment, all four external surfaces of the cuboid bolt body are provided with an uneven surface profile. FIG. 3b shows a front view of the forend-side area of the bolt 3 from FIG. 3a in the thrown locking position. Corresponding to the case of the first embodiment of FIGS. 2a and 2b, here the opening edge of the opening 10a in the forend-side housing wall is also formed complementary to the surface profile of the bolt 3.

A further embodiment of the lock is shown in FIG. 4. The lock shown in FIG. 4 comprises a latchbolt 2 with a substantially cross-shaped striking bevelled surface 2a. This latchbolt 2 is shown in detail in individual representations in FIGS. 6 to 8. The inclined striking face 2a has two crossing axes lying perpendicular to each other, wherein both axes are aligned perpendicular to the direction of the retracting and throwing motion. Here one of the two axes of the cross is longer than the other axis. In the present case, this is the axis which runs in the vertical direction when the door is in its usual operating position. In order to improve the guiding of the latchbolt into the opening assigned to it in the lock plate, the bevelled surface 2a of the latchbolt 2 has protrusions projecting at the edges. These protrusions projecting from the bevelled surface form guide protrusions which extend along the entire movement path of the latchbolt 2, as can be seen in FIG. 8. In addition, the guide protrusions which serve to inhibit break-ins form a wave structure with peaks and troughs which extend along the direction of movement. This is a surface profile, comparable to the surface profile provided in the embodiments of the bolt described previously, which is arranged to fit perfectly in the respectively assigned opening in the lock plate. This inhibition of break-ins is important in the case of latchbolts, particularly in the case of embodiments in which the latchbolt is formed as a self-locking catch bolt.

### LIST OF REFERENCE NUMBERS

1 Lock case
2 Latchbolt
2a Striking bevelled surface
3 Bolt
4 Nut
5 Lock cylinder
6 Triggering mechanism
6a Actuating arm
10 Forend
10a Opening in 10

1-16. (canceled)

17. A lock for a door or a window comprising a lock case and a lock mechanism, mounted in the lock case, which can be actuated via a manual and/or motor-driven actuator,
wherein the lock mechanism has a bolt which is mounted so as to be retractable and throwable and/or a spring-mounted retractable and throwable latchbolt, and
wherein, in the forend-side area of the lock case, an opening assigned to the bolt or an opening assigned to the latchbolt is provided, through which the bolt or the latchbolt reaches in at least one locking position, and
wherein the body of the bolt and/or the body of the latchbolt has at least one external surface which extends along the direction of movement of the retracting and throwing motion and, along this direction of extension at least in one locking section, has a constant surface profile which is formed to be uneven in the direction transverse to the direction of movement, with at least one peak and at least one trough, and
wherein the opening assigned to the bolt or/and the opening assigned to the latchbolt has/have an opening edge which is formed complementary to the contour of the uneven surface profile of the at least one external surface of the body of the bolt or of the latchbolt and, in a locking position or several locking positions of the bolt or of the latchbolt, is arranged with only a little play to the contour of the surface profile of the at least one external surface, and
wherein the body of the bolt or of the latchbolt has the design of a body which is formed from several elongate rods which are arranged next to each other transverse to their longitudinal extension and are connected to each other in one piece adjoining each other in the longitudinal direction, wherein the elongate rods of the body are formed with a round or oval cross section.

18. A lock according to claim 17, wherein the surface profile is formed convex.

19. A lock according to claim 17, wherein the surface profile is formed concave.

20. A lock according to claim 17, wherein the surface profile has at least one convex section and at least one concave section.

21. A lock according to claim 17, wherein the surface profile has a wave structure, wherein the waves extend along the direction of movement of the retracting and throwing motion.

22. A lock according to claim 21, wherein adjacent waves of the wave structure are formed to be different.

23. A lock according to claim 21, wherein the waves of the wave structure are formed identical.

24. A lock according to claim 21, wherein the waves of the wave structure are designed to be periodic.

25. A lock according to claim 17, wherein the surface profile has a toothed structure, wherein the teeth extend along the direction of movement of the retracting and throwing motion.

26. A lock according to claim 25, wherein adjacent teeth of the toothed structure are formed to be different.

27. A lock according to claim 25, wherein teeth of the toothed structure are formed identical.

28. A lock according to claim 25, wherein the teeth of the toothed structure are designed to be periodic.

29. A lock according to claim 17, wherein the body of the bolt or of the latchbolt is formed substantially as a cuboid which, transverse to the direction of movement of the retracting and throwing motion, has a cross section which is constant over the entire extension of the body in this direction, and wherein all external surfaces extending in the direction of movement of the retracting and throwing motion are formed with an uneven surface profile.

30. A lock according to claim 17, wherein the body of the bolt or of the latchbolt is formed substantially as a cuboid with an end section as a prism with a triangular cross section and has at least one external surface which is formed as an even bevelled surface as a lead-in bevel, wherein at least one of the other external surfaces of the body which extend in the direction of movement of the retracting and throwing motion is formed as an external surface with an uneven surface profile.

31. A lock according to claim 30, wherein two external surfaces of the body which lie opposite each other and are connected to each other via the lead-in bevel are formed as external surfaces with an uneven surface profile.

32. A lock according to claim 17, wherein at least some of the elongate rods are formed to be different in their cross-sectional shape and/or in their cross-sectional size.

33. A lock according to claim 17, wherein all of the elongate rods of the body are formed identical in their cross-sectional shape and in their cross-sectional size.
